(19) United States
(12) Patent Application Publication
(10) Pub. No.: US 2016/0068430 A1
(43) Pub. Date: Mar. 10, 2016

(54) PATTERNING METHOD

(71) Applicant: KABUSHIKI KAISHA TOSHIBA, Tokyo (JP)

(72) Inventors: Machiko SUENAGA, Yokohama (JP); Hideaki Sakurai, Kawasaki (JP); Takeharu Motokawa, Zushi (JP); Masatoshi Terayama, Kawasaki (JP)

(21) Appl. No.: 14/645,017

(22) Filed: Mar. 11, 2015

(30) Foreign Application Priority Data
Sep. 10, 2014 (JP) 2014-184426

(51) Int. Cl. C03C 15/00

(52) U.S. Cl. CPC C03C 15/00

(57) ABSTRACT

A patterning method according to one embodiment includes forming on a glass substrate a guide pattern including a first region at which the glass substrate is exposed, and a second region on which a pattern is formed. A self-assembly material including a first segment pinned to the first region, and a second segment is applied onto the guide pattern. The self-assembly material is phase-separated into a first domain including the first: segment and a second domain including the second segment. One of the first domain and the second domain is selectively removed. The width of the first region is not less than 0.8 times and not more than 1.15 times as large as the width of the first domain.

### CROSS REFERENCE TO RELATED APPLICATION(S)

This application is based upon and claims the benefit of priority from the prior Japanese Patent Application No. 2014-184426, filed on Sep. 10, 2014, the entire contents of which are incorporated herein by reference.

### FIELD

Embodiments described herein relate generally to a patterning method.

### BACKGROUND

A DSA (directed self-assembly) technique using a self-assembly phenomenon of a polymer material for further downsizing a semiconductor device has started to receive attention. In this technique, a BCP (block copolymer) is microphase-separated using a chemical guide or physical guide formed on a substrate, and the microphase-separated segments are selectively removed to perform patterning.

### BRIEF DESCRIPTION OF THE DRAWINGS

FIGS. 1A to 1E are sectional views showing the steps of a patterning method according to a first embodiment;

FIG. 2 is a view showing experimental results for a microphase separation pattern formed using the patterning method of FIG. 1;

FIGS. 3A and 3B are sectional views showing one example of a microphase separation step of the patterning method of FIG. 1;

FIGS. 4A to 4F are sectional views showing the steps of a patterning method according to a second embodiment;

FIGS. 5A to 5E are sectional views showing the steps of a patterning method according to a third embodiment;

FIGS. 6A to 6E are sectional views showing the steps of a patterning method according to a fourth embodiment;

FIGS. 7A to 7E are sectional views showing the steps of a patterning method according to a fifth embodiment;

FIGS. 8A to 8E are sectional views showing the steps of a patterning method according to a sixth embodiment;

FIGS. 9A to 9D are sectional views showing the steps of a patterning method according to a seventh embodiment;

FIGS. 10A to 10E are sectional views showing the steps of a patterning method according to an eighth embodiment;

FIGS. 11A to 11E are sectional views showing the steps of a patterning method according to a ninth embodiment; and

FIGS. 12A to 12D are sectional views showing the steps of a patterning method according to a tenth embodiment.

### DETAILED DESCRIPTION

Embodiments will now be explained with reference to the accompanying drawings. The present invention is not limited to the embodiments.

A patterning method according to one embodiment includes forming on a glass substrate a guide pattern including a first region at which the glass substrate is exposed, and a second region on which a pattern is formed. A self-assembly material including a first segment pinned to the first region, and a second segment is applied onto the guide pattern. The self-assembly material is phase-separated into a first domain including the first segment and a second domain including the second segment. One of the first domain and the second domain is selectively removed. The width of the first region is not less than 0.8 times and not more than 1.15 times as large as the width of the first domain.

In the patterning method in each of the following embodiments, a block copolymer (hereinafter, referred to as “BCP”) including a hydrophilic first segment and a hydrophobic second segment is used as a self-assembly material. The hydrophilicity and hydrophobicity herein refer to a relative nature showing affinity to water, and high affinity to water corresponds to hydrophilicity, while low affinity to water corresponds to hydrophobicity. The first segment is a segment having the highest affinity to water among segments contained in BCP, and the second segment is a segment having the lowest affinity to water among segments contained in BCP.

For example, when BCP is PS-b-PMMA, the first segment is PMMA (polymethyl methacrylate), and the second segment is PS (polystyrene).

In the following descriptions, the segment is neutral when its affinity to water is the middle between the affinity of the first segment and the affinity of the second segment. The segment is hydrophilic when its affinity to water is higher than that of the neutral one, and the segment is hydrophobic when its affinity to water is lower than that of the neutral one.

### First Embodiment

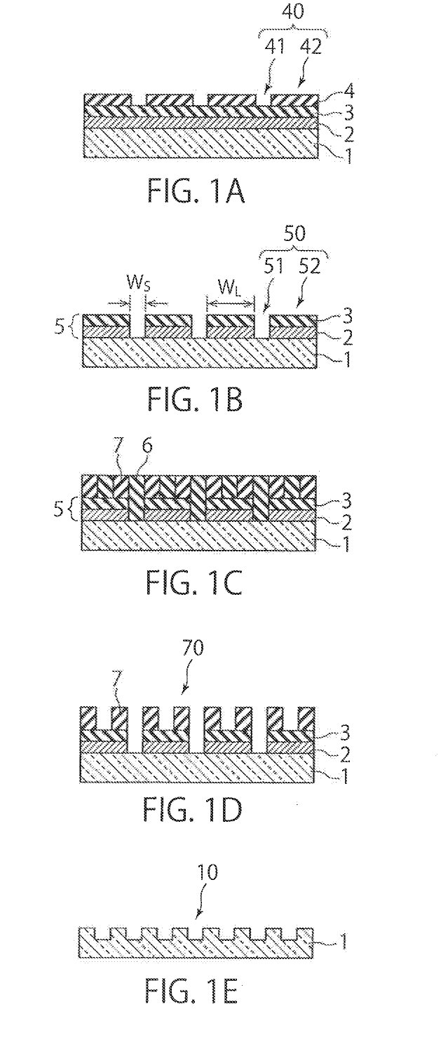

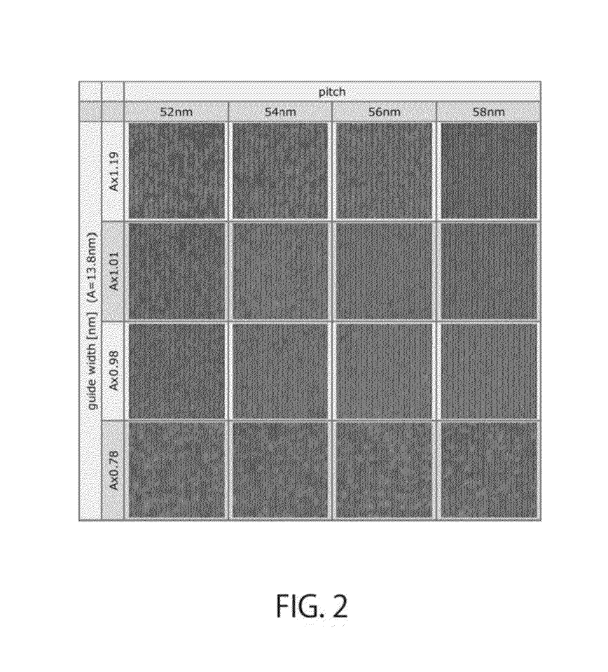

A patterning method according to the first embodiment will be described with reference to FIGS. 1 and 2. FIG. 1 is a sectional view showing the steps of the patterning method according to this embodiment.

In this embodiment, first, a hard mask 2 is formed on a glass substrate 1, a neutral layer 3 is formed on the hard mask 2, and a resist layer 4 is formed on the neutral layer 3 as shown in FIG. 1A.

The glass substrate 1 is a hydrophilic substrate as a processing object, and is, for example, a quartz glass substrate. The glass substrate 1 has a line-and-space pattern formed on a surface thereof using the patterning method.

The hard mask 2 is a metal film having hydrophilicity higher than that of the glass substrate 1, and is, for example, a chromium nitride film or a chromium oxide film. The hard mask 2 is formed by depositing a metal material such as chromium nitride or chromium oxide on the glass substrate 1 by a sputtering method. The hard mask 2 is used as a mask when the glass substrate 1 is etched in a later step. By forming the hard mask 2, the glass substrate 1 can be deeply drilled.

The neutral layer 3 is a substantially neutral film. The term “substantially neutral” means that affinity to water is lower as compared to the first segment of BCP, and higher as compared to the second segment of BCP. The neutral layer 3 may be neutral. The neutral layer 3 is formed by, for example, applying a material such as a random copolymer, which includes a first segment and a second segment, onto the hard mask 2, and baking the material. The thickness of the neutral layer 3 is, for example, 5 nm.

The resist layer 4 is formed of a resist material, and is provided with a line-and-space pattern 40. The line-and-space pattern 40 includes a space portion 41 in which a resist material is removed and the neutral layer 3 is exposed; and a line portion 42 on which a resist material is deposited. The resist layer 4 is formed by, for example, applying a resist material, on which a pattern can be drawn by electron beams, onto the neutral layer 3, drawing a pattern by electron beams, and performing development processing. The resist material contains, for example, PHS (polyhydroxystyrene). The thickness of the resist layer 4 is, for example, 30 nm.

Next, as shown in FIG. 1B, the neutral layer 3 and the hard mask 2 are etched with the resist layer 4 as a mask, and the resist layer 4 remaining on the neutral layer 3 is then stripped. The neutral layer 3 and the hard mask 2 are etched by, for example, dry etching using a plasma containing an oxygen gas. The resist layer 4 is stripped using a stripping liquid containing a polar solvent. A guide pattern 5 is hereby formed on the glass substrate 1.

The guide pattern 5 is a line-and-space pattern 50 for regularly arranging BCP in the later-described BCP microphase separation step. The line-and-space pattern 50 includes a space portion 51 and a line portion 52.

The space portion 51 is a portion in which the neutral layer 3 and the hard mask 2 are removed and the glass substrate 1 is exposed at the surface. The space portion 51 is formed so as to have a width W_{S} that is not less than 0.7 times and not more than 1.2 times as large as L₀/2.

L₀ is a pitch of a microphase separation pattern, which depends on the molecular weights of the first segment and the second segment of BCR For example, when PS-b-PMMA with L₀=30 nm is used as BCP, the space portion 51 is formed so as to have a width W_{S} of not less than 10.5 nm and not more than 18 nm.

The width W_{S} of the space portion 51 can be adjusted to fall within the above-described range by adjusting the width of the space portion 41 of the resist layer 4 and the processing amount of etching. For adjusting the width W_{S} of the space portion 51 to fall within the above-described range, for example, the width of the space portion 41 of the resist layer 4 is preferably not less than 0.7 times and not more than 1.2 times as large as L₀/2.

In the BCP microphase separation step, the space portion 51 functions as a pinning region (first region). The pinning region herein is a region that is provided with a domain serving as a starting point of arrangement of the microphase separation pattern when BCP is microphase-separated.

The line portion 52 is a portion in which the neutral layer 3 and the hard mask 2 are deposited on the glass substrate 1 and the neutral layer 3 is exposed at the surface. The line portion 52 is formed so as to have a width W_{L} that is N times as large as L₀/2 (N is an odd number of 3 or larger). For example, when PS-b-PMMA with L₀=30 nm is used as BCP, the line portion 52 is formed so as to have a width W_{L} of 45 nm.

The width W_{L} of the line portion 52 can be adjusted to fall within the above-described range by adjusting the width of the line portion 42 of the resist layer 4 and the processing amount of etching. For adjusting the width W_{L} of the line portion 52 to fall within the above-described range, for example, the width of the line portion 42 of the resist layer 4 is preferably N times as large as L₀/2.

In the BCP microphase separation step, the line portion 52 functions as a non-pinning region (second region). The non-pinning region herein is a region where domains are alternately arranged using as a starting point a domain pinned to the pinning region when BCP is microphase-separated.

Next, as shown in FIG. 1C, BCP is applied onto the guide pattern 5, and BCP is then microphase-separated. Microphase separation of BCP is performed by, for example, subjecting BCP to a heating treatment at about 240° C. for 10 minutes. The heating treatment may be performed at temperatures of glass-transition temperature (Tg) of BCP or higher. At this time, it is preferred that the inside of a chamber in which the heating treatment is performed is kept in a low-oxygen state, for example, with an oxygen concentration of 10 ppm or less. Oxidation of BCP by the heating treatment is hereby suppressed, so that abnormal arrangement of the microphase separation pattern can be suppressed. The oxygen concentration in the chamber can be reduced by introducing an inert gas such as nitrogen or argon into the chamber, or decompressing the inside of the chamber.

By the heating treatment, BCP is microphase-separated along the guide pattern 5 to form a microphase separation pattern of lamellar structure including a first domain 6 and a second domain 7.

The first domain 6 is a domain including a first segment, and has a width of approximately L₀/2. The first domain 6 is hydrophilic, and is therefore pinned to the space portion 51 of the guide pattern 5.

The second domain 7 is a domain including a second segment, and has a width of approximately L₀/2. The second domain 7 is hydrophobic, and therefore is not pinned to the space portion 51 of the guide pattern 5.

Since the width W_{S} of the space portion 51 is not less than 0.7 times and not more than 1.2 times as large as L₀/2, only one first domain 6 pinned to the space portion 51 is formed and the second domain 7 is not formed on the space portion 51.

On the other hand, the first domain 6 and the second domain 7 are alternately formed on the line portion 52 using as a starting point the first domain 6 formed on the space portion 51. More specifically, since the line portion 52 has a width W_{L} of N×L₀/2, (N−1)/2 first domains 6 and (N+1)/2 second domains 7 are alternately formed on the line portion 52.

Here, FIG. 2 is a view showing a microphase separation pattern formed when PS-b-PMMA with L₀/2=13.8 nm is used as BCP.

In FIG. 2, the abscissa represents a pitch (W_{S}+W_{L}) of the guide pattern 5, the ordinate represents a width W_{S} (guide width) of the space portion 51, and a represents a half pitch L₀/2 of PS-b-PMMA. For example, the picture on the upper left in FIG. 2 shows a microphase separation pattern formed on the guide pattern 5 having a pitch of 52 nm and a width W_{S} that is 1.19 times as large as A (13.8 nm).

From FIG. 2, it is apparent that abnormal arrangement of the microphase separation pattern is reduced as the width W_{S} becomes closer to A (L₀/2). Further, it is apparent that abnormal arrangement of the microphase separation pattern is reduced as the width W_{L} of the line portion 52 of the guide pattern 5 becomes closer to 3 times as large as A (L₀/2).

As a result of experiments, it has become apparent that when the width W_{S} of the space portion 51 is not less than 0.7 times and not more than 1.2 times as large as L₀/2 and when the width W_{L} of the line portion 52 is N times as large as L₀/2, abnormal arrangement of the microphase separation pattern is reduced.

Next, the first domain 6 is selectively removed as shown in FIG. 1D. A line-and-space pattern 70 including the second domain 7 and having a half pitch of approximately L₀/2 (nm) is hereby formed on the guide pattern 5. When BCP is PS-b-PMMA, the first domain 6 including PMMA can be removed by, for example, dry etching using a plasma containing oxygen. The line-and-space pattern 70 of the second domain 7 including PS is hereby formed.

Instead of the first domain 6, the second domain 7 may be selectively removed. In this case, a line-and-space pattern including the first domain 6 and having a half pitch of approximately L₀/2 (nm) is formed on the guide pattern 5.

Thereafter, as shown in FIG. 1E, the neutral layer 3, the hard mask 2 and the glass substrate 1 are etched with the second domain 7 as a mask, and the hard mask 2 is removed. A line-and-space pattern 10 can be hereby formed on the glass substrate 1. The hard mask 2 can be removed by, for example, dry etching. When BCP is PS-b-PMMA, for example, the line-and-space pattern 10 having a half pitch of 15 nm and a dig depth of 30 nm is formed on the glass substrate 1.

As described above, according to the patterning method according to this embodiment, only one first domain 6 is pinned to the space portion 51 by ensuring that the width W_{S} of the space portion 51 of the guide pattern 5 is not less than 0.7 times and not more than L2 times as large as L₀/2. Abnormal arrangement of the microphase separation pattern can hereby be suppressed.

The patterning method can be applied to production of the glass substrate 1 of a mask for exposure, a template for imprint, a display, a solar panel and the like.

In the patterning method, a step of irradiating the surface of the guide pattern 5 with electron beams may be added after the guide pattern 5 is formed and before BCP is applied onto the guide pattern 5. Affinity of the guide pattern 5 to BCP is hereby improved, so that abnormal arrangement of the microphase separation pattern can be further suppressed.

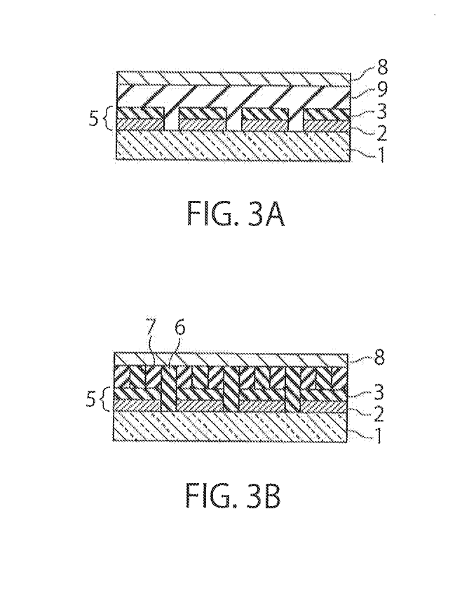

Instead of irradiating the guide pattern 5 with electron beams, the guide pattern 5 may be subjected to a plasma treatment, a UV treatment or a VUV treatment, or may be subjected to a washing treatment or slimming treatment with an alkaline or acidic chemical liquid. Further, as shown in FIG. 3A, an organic film 8 can be

formed on BCP 9 after BCP is applied onto the guide pattern 5 and before BCP is subjected to a heating treatment. In this case, as shown in FIG. 3B, BCP 9 is microphase-separated under the organic film 8 by the heating treatment. When the organic film 8 is formed, oxygen is blocked by the organic film 8 at the time of the heating treatment, and therefore oxidation of BCP 9 is suppressed, so that abnormal arrangement of the microphase separation pattern can be further suppressed. The organic film 8 is preferably substantially neutral for avoiding occurrence of abnormal arrangement due to pinning by the organic film 8. As the organic film 8, the neutral layer 3 can be used.

### Second Embodiment

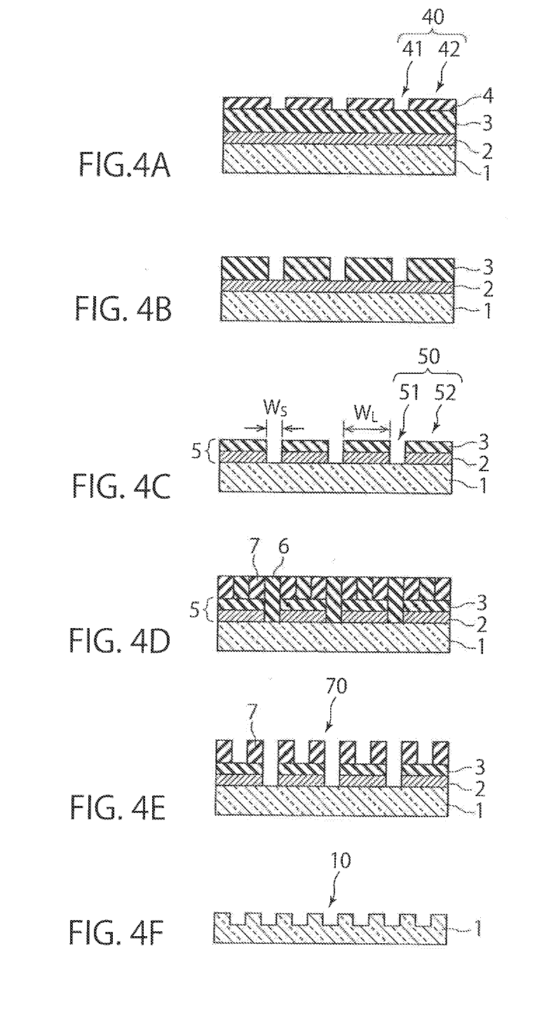

A patterning method according to the second embodiment will now be described with reference to FIG. 4. In this embodiment, etching of the hard mask 2 is performed with the neutral layer 3 as a mask. Other configurations are similar to those in the first embodiment. FIG. 4 is a sectional view showing the steps of the patterning method according to this embodiment.

In this embodiment, first, a hard mask 2 is formed on a glass substrate 1, a neutral layer 3 is formed on the hard mask 2, and a resist layer 4 is formed on the neutral layer 3 as shown in FIG. 4A.

The neutral layer 3 is used as a mask for etching the hard mask 2, and is therefore formed so as to have a thickness larger than that of the neutral layer 3 in the first embodiment. The thickness of the neutral layer 3 is, for example, 20 nm.

Next, as shown in FIG. 4B, the neutral layer 3 is etched with the resist layer 4 as a mask, and the resist layer 4 remaining on the neutral layer 3 is then stripped. The neutral layer 3 is etched by, for example, dry etching using a plasma containing an oxygen gas. The resist layer 4 is stripped using a stripping liquid containing a polar solvent.

Next, as shown in FIG. 4C, the hard mask 2 is etched with the neutral layer 3 as a mask. At this time, the processing amount of etching is adjusted so that the neutral layer 3 remains on the hard mask 2 with a predetermined thickness. The thickness of the neutral layer 3 remaining on the hard mask 2 is, for example, 5 nm. A guide pattern 5 is hereby formed on the glass substrate 1.

Subsequent steps are similar to those in the first embodiment. That is, BCP is applied onto the guide pattern 5, and BCP is microphase-separated (see FIG. 4D). A first domain 6 is selectively removed (see FIG. 4E). The neutral layer 3, the hard mask 2 and the glass substrate 1 are etched with a second domain 7 as a mask, and the hard mask 2 is removed (see FIG. 4F). A line-and-space pattern 10 can be hereby formed on the glass substrate 1.

According to this embodiment, the neutral layer 3 and the hard mask 2 are etched after the resist layer 4 is stripped. Thus, a stripping liquid for the resist layer 4 is not in contact with the surface of the guide pattern 5 formed by etching. The stripping liquid is a polar solvent, and therefore when coming into contact with the stripping liquid, the surfaces of the neutral layer 3 and the hard mask 2 may be made hydrophilic to deteriorate pinning performance of the guide pattern 5. According to this embodiment, deterioration of pinning performance f the guide pattern 5 as mentioned above can be suppressed.

### Third Embodiment

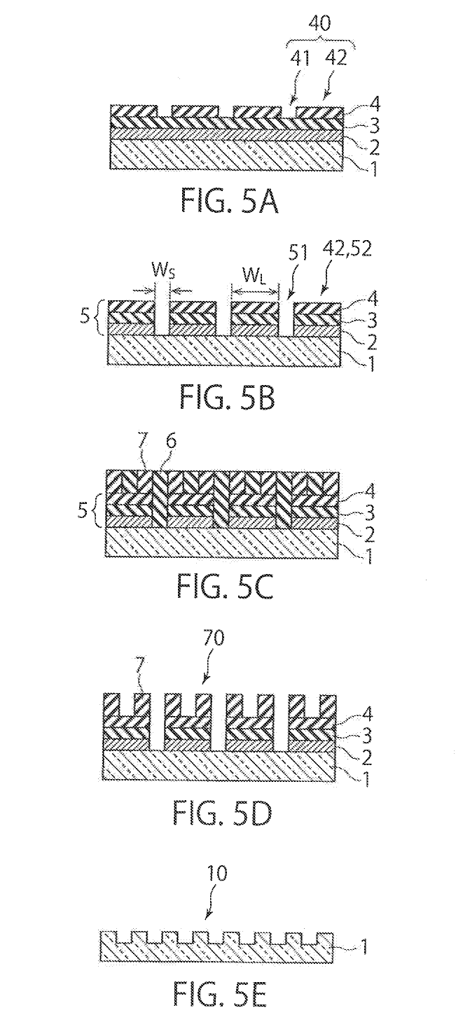

A patterning method according to the third embodiment will now be described with reference to FIG. 5. In this embodiment, the step of stripping the resist layer 4 is omitted. Other configurations are similar to those in the first embodiment. FIG. 5 is a sectional view showing the steps of the patterning method according to this embodiment.

In this embodiment, first, a hard mask 2 is formed on a glass substrate 1, a neutral layer 3 is formed on the hard mask 2, and a resist layer 4 is formed on the neutral layer 3 as shown in FIG. 5A.

The resist layer 4 is formed of a substantially neutral resist material. The resist material contains PHS.

Next, as shown in FIG. 5B, the neutral layer 3 and the hard mask 2 are etched with the resist layer 4 as a mask. A guide pattern 5 is hereby formed on the glass substrate 1. Since the resist layer 4 is not stripped, a line portion 42 of the resist layer 4 corresponds to a line portion 52 of the guide pattern 5. In this embodiment, since the resist layer 4 is formed of a substantially neutral resist material, the line portion 52 of the guide pattern 5 is a substantially neutral non-pinning region.

Subsequent steps are similar to those in the first embodiment. That is, BCP is applied onto the guide pattern 5, and BCP is microphase-separated (see FIG. 5C). A first domain 6 is selectively removed (see FIG. 5D). The resist layer 4, the neutral layer 3, the hard mask 2 and the glass substrate 1 are etched with a second domain 7 as a mask, and the hard mask 2 is removed (see FIG. 5E). A line-and-space pattern 10 can be hereby formed on the glass substrate 1.

According to this embodiment, the step of stripping the resist layer 4 can be omitted, and therefore the process can be simplified. According to this embodiment, the stripping liquid for stripping the resist layer 4 is not in contact with the surface of the guide pattern 5, and therefore deterioration of pinning performance of the guide pattern 5 can be suppressed.

### Fourth Embodiment

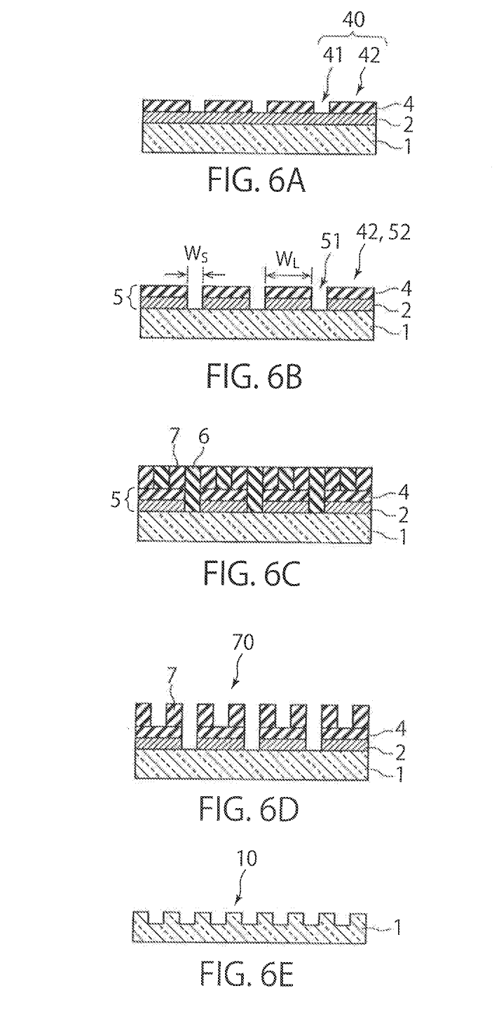

A patterning method according to the fourth embodiment will now be described with reference to FIG. 6. In this embodiment, the step of forming the neutral layer 3 and the step of stripping the resist layer 4 are omitted. Other configurations are similar to those in the first embodiment. FIG. 6 is a sectional view showing the steps of the patterning method according to this embodiment.

In this embodiment, first, a hard mask 2 is formed on a glass substrate 1, and a resist layer 4 is formed on the hard mask 2 as shown in FIG. 6A. A neutral layer 3 is not formed.

The resist layer 4 is formed of a substantially neutral resist material. The resist material contains PHS.

Next, as shown in FIG. 6B, the hard mask 2 is etched with the resist layer 4 as a mask. A guide pattern 5 is hereby formed on the glass substrate 1. In this embodiment, since the resist layer 4 is not stripped, a line portion 42 of the resist layer 4 corresponds to a line portion 52 of the guide pattern 5. Since the resist layer 4 is formed of a substantially neutral resist material, the line portion 52 of the guide pattern 5 is a substantially neutral non-pinning region.

Subsequent steps are similar to those in the first embodiment. That is, BCP is applied onto the guide pattern 5, and BCP is microphase-separated (see FIG. 6C). A first domain 6 is selectively removed (see FIG. 6D). The resist layer 4, the hard mask 2 and the glass substrate 1 are etched with a second domain 7 as a mask, and the hard mask 2 is removed (see FIG. 6E). A line-and-space pattern 10 can be hereby formed on the glass substrate 1.

According to this embodiment, the step of forming the neutral layer 3 and the step of stripping the resist layer 4 can be omitted, so that the process can be simplified. According to this embodiment, the stripping liquid for stripping the resist layer 4 is not in contact with the surface of the guide pattern 5, and therefore deterioration of pinning performance of the guide pattern 5 can be suppressed.

### Fifth Embodiment

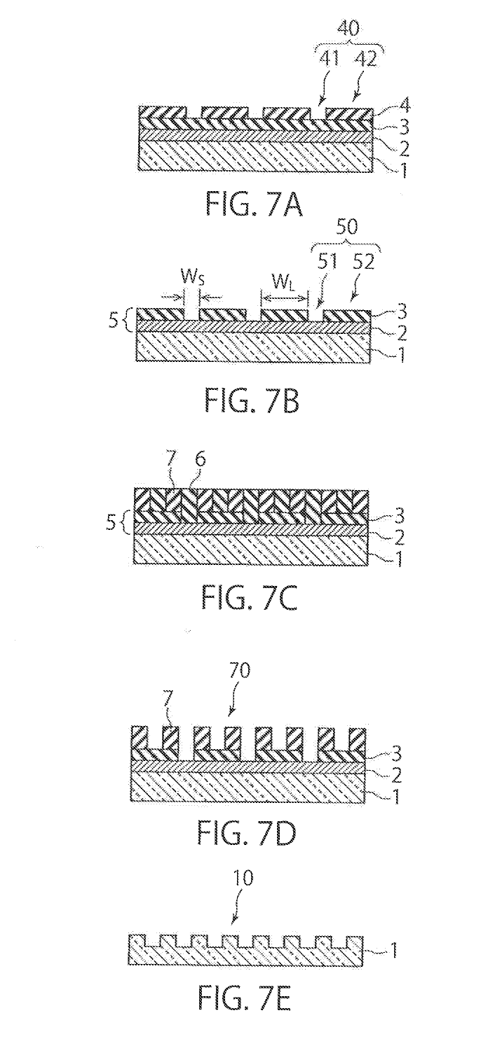

A patterning method according to the fifth embodiment will now be described with reference to FIG. 7. In the first to fourth embodiments, the pinning region of the guide pattern 5 is composed of the glass substrate 1, while in this embodiment, the pinning region of the guide pattern 5 is composed of the hard mask 2. A width W_{S} of a space portion 51 is not less than 0.8 times and not more than 1.1 times as large as L₀/2. Other configurations are similar to those in the first embodiment. FIG. 7 is a sectional view showing the steps of the patterning method according to this embodiment.

In this embodiment, first, a hard mask 2 is formed on a glass substrate 1, a neutral layer 3 is formed on the hard mask 2, and a resist layer 4 is formed on the neutral layer 3 as shown in FIG. 7A. This configuration is similar to that in the first embodiment.

Next, as shown in FIG. 7B, the neutral layer 3 is etched with the resist layer 4 as a mask, and the resist layer 4 remaining on the neutral layer 3 is then stripped. A guide pattern 5 is hereby formed on the glass substrate 1.

In this embodiment, since etching of the hard mask 2 is not performed, the space portion 51 of the guide pattern 5 is a portion in which the neutral layer 3 is removed, and the hard mask 2 is exposed. As described above, the hard mask 2 is a metal film having hydrophilicity higher than that of the glass substrate 1. Therefore, the space portion 51 including the hard mask 2 is a pinning region that pins a first segment similarly to the space portion 51 in the first embodiment.

In this embodiment, the space portion 51 is formed so as to have the width W_{S} that is not less than 0.8 times and not more than 1.1 times as large as L₀/2. For example, when PS-b-PMMA with L₀=30 nm is used as BCP, the space portion 51 is formed so as to have the width W_{S} of not less than 12 nm and not more than 16.5 nm. This range of the width W_{S} is a range determined experimentally as a range that allows abnormal arrangement of the microphase separation pattern to be suppressed.

The width W_{S} of the space portion 51 can be adjusted to fall within the above-described range by adjusting the width of the space portion 41 of the resist layer 4 and the processing amount of etching. For adjusting the width W_{S} of the space portion 51, for example, the width of the space portion 41 of the resist layer 4 is preferably not less than 0.8 times and not more than 1.1 times as large as L₀/2.

As described above, hydrophilicity of the hard mask 2 is higher than that of the glass substrate 1, and therefore a first domain 6 is more strongly pinned to the pinning region in this embodiment. Arrangement of the microphase separation pattern is more significantly influenced by the position shift of the first domain 6 as the first domain 6 is more strongly pinned. Thus, the range of the width W_{S} of the space portion 51 in this embodiment is narrower than the range of the width W_{S} of the space portion 51 in the first to fourth embodiments.

Subsequent steps are similar to those in the first embodiment. That is, BCP is applied onto the guide pattern 5, and BCP is microphase-separated (see FIG. 7C). The first domain 6 is selectively removed (see FIG. 7D). The neutral layer 3, the hard mask 2 and the glass substrate 1 are etched with a second domain 7 as a mask, and the hard mask 2 is removed (see FIG. 7E). A line-and-space pattern 10 can be hereby formed on the glass substrate 1 similarly to the first embodiment.

According to this embodiment, only one first domain 6 is pinned to the space portion 51 by ensuring that the width W_{S} of the space portion 51 of the guide pattern 5 is not less than 0.8 times and not more than 1.1 times as large as L₀/2. Abnormal arrangement of the microphase separation pattern can hereby be suppressed.

Since the guide pattern 5 is formed using the hydrophilic hard mask 2, the processing object is not limited to the hydrophilic glass substrate 1. Therefore, the patterning method can be applied not only to production of the glass substrate 1 of a mask for exposure, a template for imprint, a display, a solar panel and the like, but also to production of a semiconductor substrate and any processing target layer.

### Sixth Embodiment

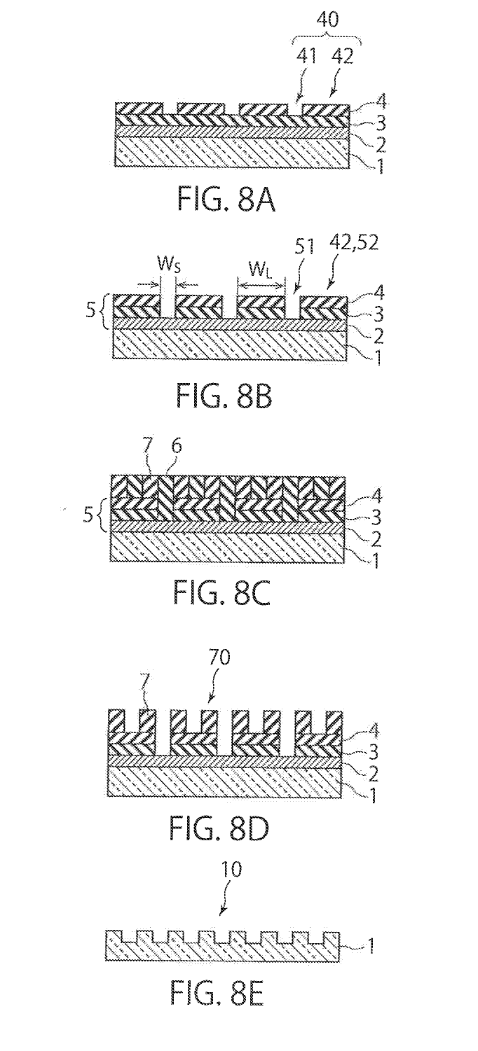

A patterning method according to the sixth embodiment will now be described with reference to FIG. 8. In this embodiment, the step of stripping the resist layer 4 is omitted. Other configurations are similar to those in the fifth embodiment. FIG. 8 is a sectional view showing the steps of the patterning method according to this embodiment.

In this embodiment, first, a hard mask 2 is formed on a glass substrate 1, a neutral layer 3 is formed on the hard mask 2, and a resist layer 4 is formed on the neutral layer 3 as shown in FIG. 8A.

The resist layer 4 is formed of a substantially neutral resist material. The resist material contains PHS.

Next, as shown in FIG. 8B, the neutral layer 3 is etched with the resist layer 4 as a mask. A guide pattern 5 is hereby formed on the glass substrate 1. Since the resist layer 4 is not stripped, a line portion 42 of the resist layer 4 corresponds to a line portion 52 of the guide pattern 5. In this embodiment, since the resist layer 4 is formed of a substantially neutral material, the line portion 52 of the guide pattern 5 is a substantially neutral non-pinning region.

Subsequent steps are similar to those in the fifth embodiment. That is, BCP is applied onto the guide pattern 5, and BCP is microphase-separated (see FIG. 8C). A first domain 6 is selectively removed (see FIG. 8D). The resist layer 4, the neutral layer 3, the hard mask 2 and the glass substrate 1 are etched with a second domain 7 as a mask, and the hard mask 2 is removed (see FIG. 8E). A line-and-space pattern 10 can be hereby formed on the glass substrate 1.

According to this embodiment, the step of stripping the resist layer 4 can be omitted, and therefore the process can be simplified. According to this embodiment, the stripping liquid for stripping the resist layer 4 is not in contact with the surface of the guide pattern 5, and therefore deterioration of pinning performance of the guide pattern 5 can be suppressed.

### Seventh Embodiment

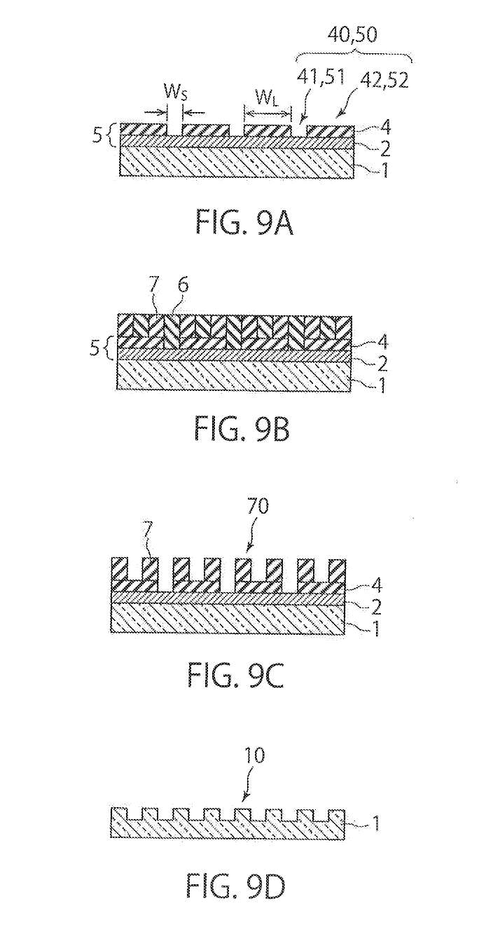

A patterning method according to the seventh embodiment will now be described with reference to FIG. 9. In this embodiment, the step of forming the neutral layer 3 and the step of stripping the resist layer 4 are omitted. Other configurations are similar to those in the fifth embodiment. FIG. 9 is a sectional view showing the steps of the patterning method according to this embodiment.

In this embodiment, first, a hard mask 2 is formed on a glass substrate 1, and a resist layer 4 is formed on the hard mask 2 as shown in FIG. 9A. A neutral layer 3 is not formed.

The resist layer 4 is formed of a substantially neutral resist material. The resist material contains PHS.

A guide pattern 5 is hereby formed on the glass substrate 1. In this embodiment, since the resist layer 4 is not stripped, a line portion 42 of the resist layer 4 corresponds to a line portion 52 of the guide pattern 5. Since the resist layer 4 is formed of a substantially neutral resist material, the line portion 52 of the guide pattern 5 is a substantially neutral non-pinning region.

Subsequent steps are similar to those in the fifth embodiment. That is, BCP is applied onto the guide pattern 5, and BCP is microphase-separated (see FIG. 9B). A first domain 6 is selectively removed (see FIG. 9C). The resist layer 4, the hard mask 2 and the glass substrate 1 are etched with a second domain 7 as a mask, and the hard mask 2 is removed (see FIG. 9D). A line-and-space pattern 10 can be hereby formed on the glass substrate 1.

According to this embodiment, the step of forming the neutral layer 3 and the step of stripping the resist layer 4 can be omitted, so that the process can be simplified. According to this embodiment, the stripping liquid for stripping the resist layer 4 is not in contact with the surface of the guide pattern 5, and therefore deterioration of pinning performance of the guide pattern 5 can be suppressed.

### Eighth Embodiment

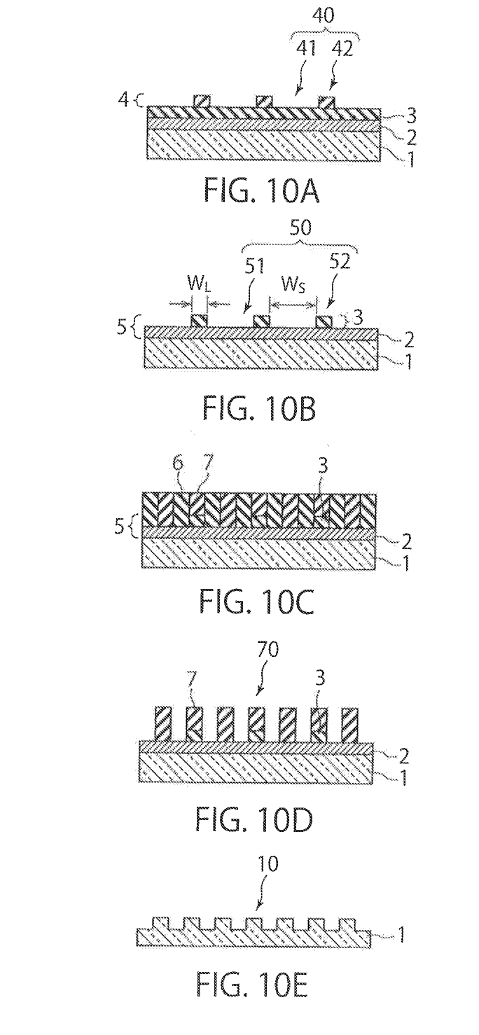

A patterning method according to the eighth embodiment will now be described with reference to FIG. 10. In the first to seventh embodiments, the space portion 51 of the guide pattern 5 functions as a pinning region, while in this embodiment, the line portion 52 of the guide pattern 5 functions as a pinning region. The width W_{L} of the line portion 52 is not less than 0.9 times and not more than 1.2 times as large as L₀/2. Other configurations are similar to those in the fifth embodiment. FIG. 10 is a sectional view showing the steps of the patterning method according to this embodiment.

In this embodiment, first, a hard mask 2 is formed on a glass substrate 1, a neutral layer 3 is formed on the hard mask 2, and a resist layer 4 is formed on the neutral layer 3 as shown in FIG. 10A.

In this embodiment, the neutral layer 3 is hydrophobic. The neutral layer 3 is formed of, for example, a random copolymer containing a second segment in an amount larger than that of a first segment, or any other hydrophobic material.

Next, as shown in FIG. 10B, the neutral layer 3 is etched with the resist layer 4 as a mask, and the resist layer 4 remaining on the neutral layer 3 is then stripped. A guide pattern 5 is hereby formed on the glass substrate 1.

In this embodiment, the line portion 52 of the guide pattern 5 is a portion in which the neutral layer 3 and the hard mask 2 are deposited on the glass substrate 1 and the neutral layer 3 is exposed at the surface. The line portion 52 is formed so as to have a width W_{L} that is not less than 0.9 times and not more than 1.2 times as large as L₀/2. For example, when PS-b-PMMA with L₀=30 nm is used as BCP, the line portion 52 is formed so as to have a width W_{L} of not less than 13.5 nm and not more than 18 nm. This range of the width W_{S} is a range determined experimentally as a range that allows abnormal arrangement of the microphase separation pattern to be suppressed. In the BCP microphase separation step, the line portion 52 functions as a pinning region.

The width W_{L} of the line portion 52 can be adjusted to fall within the above-described range by adjusting the width of the line portion 42 of the resist layer 4 and the processing amount of etching. For adjusting the width W_{L} of the line portion 52 to fall within the above-described range, for example, the width of the line portion 42 of the resist layer 4 is preferably not less than 0.9 times and not more than 1.2 times as large as L₀/2.

The space portion 51 is a portion in which the neutral layer 3 is removed and the hard mask 2 is exposed at the surface. The space portion 51 is formed so as to have a width W_{S} that is N times as large as L₀/2. For example, when PS-b-PMMA with L₀=30 nm is used as BCP, the space portion 51 is formed so as to have a width W_{S} of 45 nm. In the BCP microphase separation step, the space portion 51 functions as a non-pinning region.

The width W_{S} of the space portion 51 can be adjusted to fall within the above-described range by adjusting the width of the space portion 41 of the resist layer 4 and the processing amount of etching. For adjusting the width W_{S} of the space portion 51 to fall within the above-described range, for example, the width of the space portion 41 of the resist layer 4 is preferably N times as large as L₀/2.

Next, as shown in FIG. 10C, BCP is applied onto the guide pattern 5, and BCP is microphase-separated. Microphase separation of BCP is performed by, for example, subjecting BCP to a heating treatment at about 240° C. for 10 minutes.

By the heating treatment, BCP is microphase-separated along the guide pattern 5 to form a microphase separation pattern of lamellar structure including a first domain 6 and a second domain 7.

The second domain 7 is hydrophobic, and is therefore pinned to the line portion 52 of the guide pattern 5. The first domain 6 is hydrophilic, and therefore is not pinned to the line portion 52 of the guide pattern 5.

Since the width W_{L} of the line portion 52 is not less than 0.9 times and not more than 1.2 times as large as L₀/2, only one second domain 7 pinned to the line portion 52 is formed and the first domain 6 is not formed on the line portion 52.

On the other hand, the first domain 6 and the second domain 7 are alternately formed on the space portion 51 using as a starting point the second domain 7 formed on the line portion 52. More specifically, since the space portion 51 has a width W_{S} that is N times as large as L₀/2, (N−1)/2 second domains 7 and (N+1)/2 first domains 6 are alternately formed on the space portion 51.

Subsequent steps are similar to those in the fifth embodiment. That is, the first domain 6 is selectively removed (see FIG. 10D). The hard mask 2 and the glass substrate 1 are etched with the second domain 7 as a mask, and the hard mask 2 is removed (see FIG. 10E). A line-and-space pattern 10 can be hereby formed on the glass substrate 1.

According to this embodiment, only one second domain 7 is pinned to the line portion 52 by ensuring that the width W_{L} of the line portion 52 of the guide pattern 5 is not less than 0.9 times and not more than 1.2 times as large as L₀/2. Abnormal arrangement of the microphase separation pattern can hereby be suppressed.

Since the guide pattern 5 is formed using the hydrophilic hard mask 2, the processing object is not limited to the hydrophilic glass substrate 1. Therefore, the patterning method can be applied not only to production of the glass substrate 1 of a mask for exposure, a template for imprint, a display, a solar panel and the like, but also to production of a semiconductor substrate and any processing target layer.

Further, as shown in FIG. 10D, the space portion of a line-and-space pattern 70 of the second domain 7 is flat, and therefore the dig depth of the glass substrate 1 with the second domain 7 as a mask can be made uniform.

### Ninth Embodiment

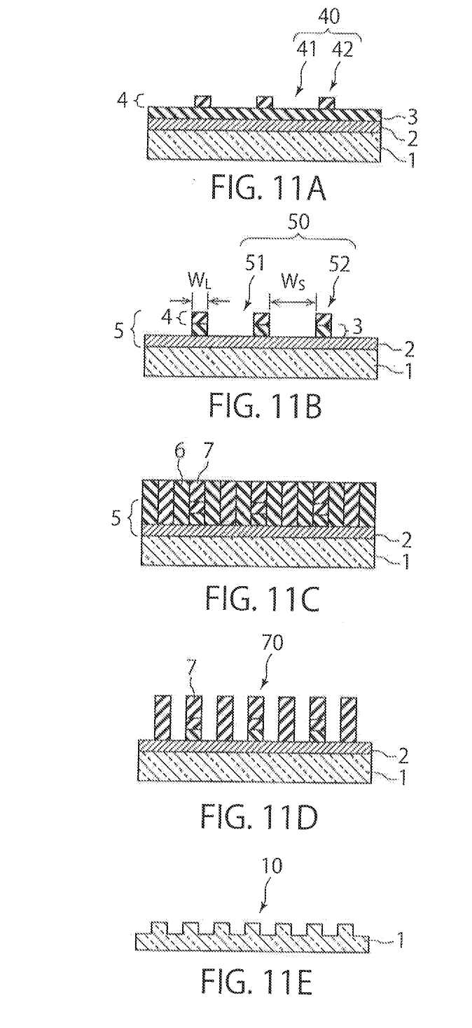

A patterning method according to the ninth embodiment will now be described with reference to FIG. 11. In this embodiment, the step of stripping the resist layer 4 is omitted. Other configurations are similar to those in the eighth embodiment. FIG. 11 is a sectional view showing the steps of the patterning method according to this embodiment.

In this embodiment, first, a hard mask 2 is formed on a glass substrate 1, a neutral layer 3 is formed on the hard mask 2, and a resist layer 4 is formed on the neutral layer 3 as shown in FIG. 11A.

The resist layer 4 is formed of a hydrophobic resist material.

Next, as shown in FIG. 11B, the neutral layer 3 is etched with the resist layer 4 as a mask. A guide pattern 5 is hereby formed on the glass substrate 1. Since the resist layer 4 is not stripped, a line portion 42 of the resist layer 4 corresponds to a line portion 52 of the guide pattern 5. The space portion 51 of the guide pattern 5 is a portion in which the hard mask 2 is exposed. In this embodiment, since the line portion 42 of the resist layer 4 is formed of a hydrophobic material, the line portion 52 of the guide pattern 5 is a hydrophobic pinning region similarly to the eighth embodiment.

Subsequent steps are similar to those in the eighth embodiment. That is, BCP is applied onto the guide pattern 5, and BCP is microphase-separated (see FIG. 11C). A first domain 6 is selectively removed (see FIG. 11D). The hard mask 2 and the glass substrate 1 are etched with a second domain 7 as a mask, and the hard mask 2 is removed (see FIG. 11E). A line-and-space pattern 10 can be hereby formed on the glass substrate 1.

According to this embodiment, the step of stripping the resist layer 4 can be omitted, and therefore the process can be simplified. According to this embodiment, the stripping liquid for stripping the resist layer 4 is not in contact with the surface of the guide pattern 5, and therefore deterioration of pinning performance of the guide pattern 5 can be suppressed.

### Tenth Embodiment

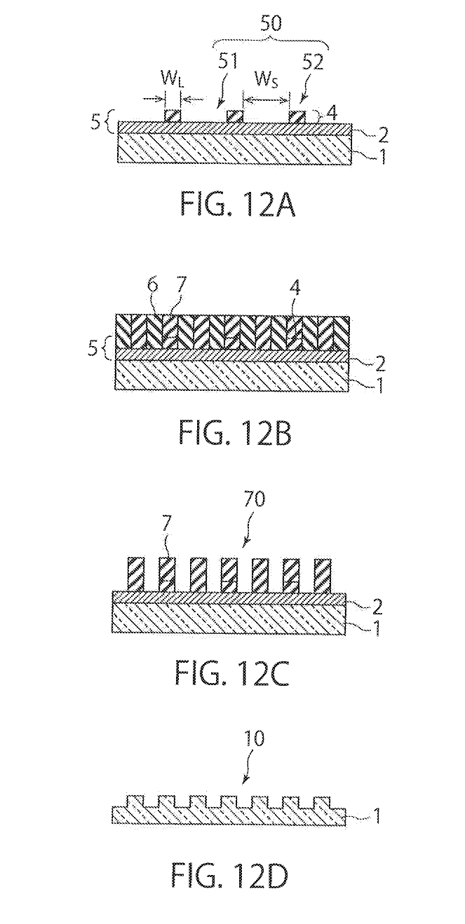

A patterning method according to the tenth embodiment will now be described with reference to FIG. 12. In this embodiment, the step of forming the neutral layer 3 and the step of stripping the resist layer 4 are omitted. Other configurations are similar to those in the eighth embodiment. FIG. 12 is a sectional view showing the steps of the patterning method according to this embodiment.

In this embodiment, first, a hard mask 2 is formed on a glass substrate 1, and a resist layer 4 is formed on the hard mask 2 as shown in FIG. 12A. A neutral layer 3 is not formed, The resist layer 4 is formed of a hydrophobic resist material. A guide pattern 5 is hereby formed on the glass substrate 1.

In this embodiment, since the resist layer 4 is not stripped, a line portion 42 of the resist layer 4 corresponds to a line portion 52 of the guide pattern 5. Since the resist layer 4 is formed of a hydrophobic resist material, the line portion 52 of the guide pattern 5 is a hydrophobic pinning region.

Subsequent steps are similar to those in the eighth embodiment. That is, BCP is applied onto the guide pattern 5, and BCP is microphase-separated (see FIG. 12B). A first domain 6 is selectively removed (see FIG. 12C). The hard mask 2 and the glass substrate 1 are etched with a second domain 7 as a mask, and the hard mask 2 is removed (see FIG. 12D). A line-and-space pattern 10 can be hereby formed on the glass substrate 1.

According to this embodiment, the step of forming the neutral layer 3 and the step of stripping the resist layer 4 can be omitted, so that the process can be simplified. According to this embodiment, the stripping liquid for stripping the resist layer 4 is not in contact with the surface of the guide pattern 5, and therefore deterioration of pinning performance of the guide pattern 5 can be suppressed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A patterning method comprising:
forming on a glass substrate a guide pattern including a first region at which the glass substrate is exposed, and a second region on which a pattern is formed;
applying onto the guide pattern a self-assembly material including a first segment pinned to the first region, and a second segment;
phase-separating the self-assembly material into a first domain including the first segment and a second domain including the second segment; and
selectively removing one of the first domain and the second domain,
wherein the width of the first region is not less than 0.8 times and not more than 1.15 times as large as the width of the first domain.

2. The method according to claim 1, wherein
the formation of the guide pattern comprises:
forming a hard mask on the glass substrate;
forming a neutral layer on the hard mask;
forming a resist pattern on the neutral layer;
etching the neutral layer and the hard mask with the resist pattern as a mask; and
stripping the resist pattern.

3. The method according to claim 1, wherein
the formation of the guide pattern comprises:
forming a hard mask on the glass substrate;
forming a neutral layer on the hard mask;
forming a resist pattern on the neutral layer;
etching the neutral layer with the resist pattern as a mask;
stripping the resist pattern; and
etching the hard mask with the neutral layer as a mask.

4. The method according to claim 1, wherein
the formation of the guide pattern comprises:
forming a hard mask on the glass substrate;
forming a neutral layer on the hard mask;
forming a resist pattern on the neutral layer; and
etching the neutral layer and the hard mask with the resist pattern as a mask.

5. The method according to claim 1, wherein
the formation of the guide pattern comprises:
forming a hard mask on the glass substrate; and
forming a resist pattern on the hard mask.

6. A patterning method comprising:
forming on a glass substrate a hard mask including a Cr-containing metal;
forming on the hard mask a guide pattern including a first region at which the hard mask is exposed, and a second region on which a pattern is formed;
applying onto the guide pattern a self-assembly material including a first segment pinned to the first region, and a second segment;
phase-separating the self-assembly material into a first domain including the first segment and a second domain including the second segment; and
selectively removing one of the first domain and the second domain, wherein the width of the first region is not less than 0.85 times and not more than 1.05 times as large as the width of the first domain.

7. The method according to claim 6, wherein
the formation of the guide pattern comprises:
forming a neutral layer on the hard mask;
forming a resist pattern on the neutral layer;
etching the neutral layer with the resist pattern as a mask; and
stripping the resist pattern.

8. The method according to claim 6, wherein
the formation of the guide pattern comprises:
forming a neutral layer on the hard mask;
forming a resist pattern on the neutral layer; and
etching the neutral layer with the resist pattern as a mask.

9. The method according to claim 6, wherein
the formation of the guide pattern comprises forming a resist pattern on the hard mask.

10. A patterning method comprising:
forming on a glass substrate a hard mask including a Cr-containing metal;
forming on the hard mask a guide pattern including a first region on which a pattern is formed, a second region at which the hard mask is exposed;
applying onto the guide pattern a self-assembly material including a first segment, and a second segment pinned to the first region;
phase-separating the self-assembly material into a first domain including the first segment and a second domain including the second segment; and
selectively removing one of the first domain and the second domain, wherein the width of the first region is not less than 0.95 times and not more than 1.15 times as large as the width of the second domain.

11. The method according to claim 10, wherein
the formation of the guide pattern comprises:
forming a neutral layer on the hard mask;
forming a resist pattern on the neutral layer;
etching the neutral layer with the resist pattern as a mask; and
stripping the resist pattern.

12. The patterning method according to claim 10, wherein
the formation of the guide pattern comprises:
forming a neutral layer on the hard mask;
forming a resist pattern on the neutral layer; and
etching the neutral layer with the resist pattern as a mask.

13. The method according to claim 10, wherein
the formation of the guide pattern comprises forming a resist pattern on the hard mask.
